(19) United States
(12) Patent Application Publication
(10) Pub. No.: US 2017/0074340 A1
(43) Pub. Date: Mar. 16, 2017

(54) Brake Lining Apparatus For A Disc Brake

(71) Applicant: MAN TRUCK & BUS AG, München (DE)

(72) Inventor: Florian ORGLER, München (DE)

(73) Assignee: MAN TRUCK & BUS AG

(21) Appl. No.: 15/257,141

(22) Filed: Sep. 6, 2016

(30) Foreign Application Priority Data
Sep. 12, 2015 (DE) 102015011973.7

(51) Int. Cl. F16D 69/00; F16D 65/092

(52) U.S. Cl. CPC F16D 69/00; F16D 65/092; F16D 2069/004

(57) ABSTRACT

A brake lining apparatus for a disc brake, including a brake lining holder and a brake lining applied on an application face of the brake lining holder. The brake lining is distinguished by the fact that a frictional face which is con-figured by way of the lining upper side of the brake lining is at most 75% of the size of the application face of the brake lining holder. This increases the surface pressure of the brake lining, with the result that it experiences a load even in the case of very low actuating forces, in order thus to prevent a permanent premature loss of the coefficient of friction of the brake linings, in particular in the case of vehicles with a hybrid drive.

### BACKGROUND OF THE INVENTION

1. Field of the Invention

The present invention relates to a brake lining apparatus for a disc brake.

2. Description of the Related Art

FIG. 9 shows, by way of example, a typical brake lining apparatus 91 known from the prior art. The brake lining apparatus 91 comprises a brake lining holder 2 in the form of a lining carrier plate and a brake lining 94 which is applied on an application face 3 of the brake lining holder 2 and forms a frictional face 95 on its upper side. The brake lining 94 consists of a brake lining material suitable for tribological interaction with a corresponding frictional element, such as a brake disc here. A thin groove 96 can be made in the brake lining in order to receive abrasion particles produced on the frictional surface 95 during braking operation.

From practice, in particular in the case of urban buses with a hybrid drive, cases are known, in which the brake linings have lost their coefficient of friction permanently and irretrievably on account of low loading and wear. This phenomenon is also called “falling asleep” of the brake linings. This effect is produced by virtue of the fact that the greatest proportion of the braking performance of the said vehicles is applied by way of a permanent braking device such as a retarder or by way of recuperation operations and not by way of the service brake apparatus. “Falling asleep” of this type and the associated drop in the coefficient of friction of the brake linings represent a safety risk and increases the operating costs for the vehicle, because the brake linings have to be replaced prematurely, although they are scarcely used.

### SUMMARY OF THE INVENTION

It is an object of one aspect of the invention to provide an improved brake lining apparatus for a disc brake, by way of which disadvantages of conventional brake lining apparatuses can be avoided. In particular, it is an object of the invention to provide a brake lining apparatus suitable for use in the case of vehicles with a hybrid drive, in particular in the case of commercial vehicles with a hybrid drive, and does not have any premature and permanent loss of the coefficient of friction.

According to general aspects of the invention, a brake lining apparatus for a disc brake is provided that comprises, in a manner known per se, a brake lining holder and a brake lining which is applied on an application face of the brake lining holder. The brake lining holder is usually configured as a carrier plate and is also called a lining carrier plate or lining rear plate and, furthermore, can have what are known as underlayer intermediate layers. The lining up-per side of the brake lining serves as a frictional face for tribological interaction with a friction-al element, for example a brake disc. The brake lining apparatus is typically inserted into a lining shaft, for example, in the case of a disc brake. Via a brake application unit which is arranged on that side of the brake lining holder which faces away from the brake lining, the brake lining apparatus can be pressed against a brake disc, in order to interact tribologically with the latter. The application face is therefore that surface face of the brake lining holder which faces the brake disc in the mounted state of the brake lining holder.

A brake lining apparatus according to the invention is distinguished by the fact that the frictional face, which is configured by way of the lining upper side of the brake lining is at most 75% of the size of the possible application face of the brake lining holder, with the result that, in a plan view of the brake lining apparatus with a view onto the frictional face, the frictional face covers at most 75% of the application face. In other words, the surface of the upper side of the brake lining is at most 75% as large as the application face of the brake lining holder. According to one preferred embodiment, the frictional face can be at most 60% of the size of the application face of the brake lining. According to a further variant, the frictional face can be at most 50% of the size of the application face of the brake lining holder.

This deliberate reduction of the frictional face, which is configured by way of the brake lining or the brake lining material, considerably increases the surface pressure on the lining material that occurs during braking operation. As a result, “falling asleep” of the brake linings can be reliably prevented despite the reduced use of brakes in the case of a hybrid drive. At the same time, the invention affords the further advantage that the conventional connector dimensions and existing structural configurations, in particular for the brake calliper, brake carrier and brake disc and also existing brake lining holders, can be used further and complex structural additional outlays can thus be avoided.

By way of the reduced size of the frictional face and the resulting increase in the surface pressure, the brake lining therefore experiences a load even in the case of very low actuating forces, as tend to be customary in the case of a hybrid vehicle, which load lies in a similar proportion as the brake lining would have in comparable applications without permanent braking devices or recuperation braking operations. The brake lining can be fastened on the brake lining holder in a manner known per se, for example by way of adhesive bonding or sintering.

The brake lining apparatus can therefore have one or more cut-outs, in particular large-area cut-outs, which represent brake lining-free locations on the application face of the brake lining holder or at least represent regions, in which the brake lining applied has a lower depth than at other locations and does not form a frictional face as a result.

By way of the number, shape, area and/or position of cut-outs of this type, the wear behavior of the lining can be optimized and the wear volume can be adapted to the respective application.

For example, the brake lining can have recesses that extend from the frictional face as far as the application face, with the result that the depth of the cut-out reaches as far as the lining rear plate. The depth of the cut-out can also be fixed in a variable manner, however.

The brake lining can have recesses that extend from the frictional face in the direction of the application face, but not as far as the application face. According to this de-sign variant, a fastening face of the brake lining is configured on the lining underside of the brake lining and is fastened to the application face covers more than 75% of the application face, further preferably more than 90% of the application face. This design variant affords the advantage that it provides the brake lining material with more retention on the brake lining holder and therefore reduces the risk that the lining is sheared off.

A further possibility to improve the retention of the lining material on the brake lining holder is if the frictional face has recesses that have a cross section that tapers in the direction of the application face. It is emphasized, however, that it is also possible that the recesses have a cross section that does not taper, for example by the recesses being of groove-shaped or cylindrical configuration.

According to a further embodiment, the frictional face can have strip-shaped recesses and/or depressions. The strip-shaped recesses and/or depressions can be configured as parallel recesses in the longitudinal direction or in the transverse direction of the application face. The number of strip-shaped recesses can be at least three.

Here, one variant provides that the strip-shaped recesses extend from an edge region of the application face to an opposite edge region of the application face. Another variant provides that the strip-shaped recesses are surrounded on the circumferential side by the brake lining, that is to say the length of a strip-shaped recess is smaller than the distance between two edge regions that lie opposite one another.

A further possibility for the implementation according to one aspect of the invention provides that the frictional face has two recesses surrounded in each case by the brake lining. Here, the recesses can be of cylindrical configuration or can have an angular cross section that can be adapted, for example, to the outer contour of the brake lining holder. However, the frictional face can also have a multiplicity of recesses, for example can have at least ten recesses which, for example, are of cylindrical configuration and/or are configured as conical recesses and are surrounded in each case by the brake lining. This design variant affords the advantage that the distances between the different contact regions of the frictional face do not become too great.

According to a further embodiment, the brake lining is applied flatly to the application face at two points that are separate from one another. According to one variant of this embodiment, the brake lining can be applied, for example, in a cylindrical manner and onto circular faces of the application face, which are disjoint from one another. Outside those points, on which the friction lining is applied, a free surface is therefore formed, on which no brake lining is provided on the application face and which makes up at least 25% of the application face.

According to a further aspect of the invention, a hybrid vehicle, in particular a commercial vehicle with a hybrid drive, is provided, comprising a brake lining apparatus as described in this document. The above-described preferred embodiments and features of the invention can be combined with one another in any desired manner.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Further details and advantages of the invention will be described in the following text with reference to the appended drawings, in which:

FIGS. 1 to 7 each show a plan view of a brake lining apparatus according to different exemplary embodiments of the invention;

FIG. 8 is a cross-sectional view of a brake lining apparatus according to one exemplary embodiment of the invention; and

FIG. 9 is a perspective view of a brake lining apparatus which is known from the prior art.

### DETAILED DESCRIPTION OF THE PRESENTLY PREFERRED EMBODIMENTS

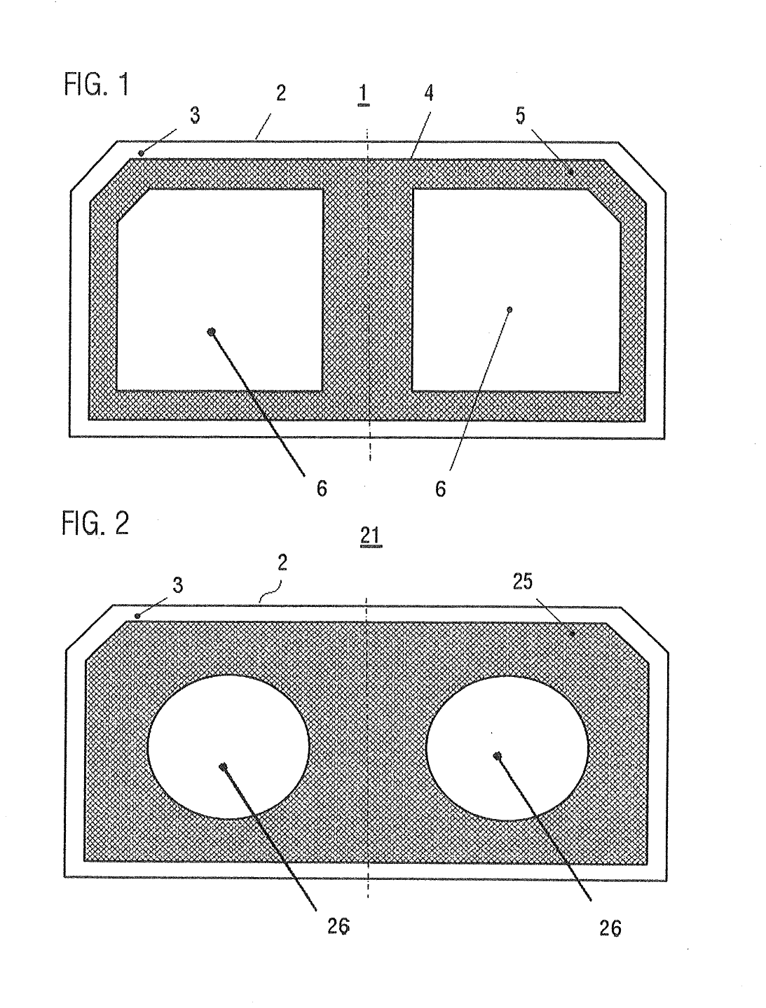

FIG. 1 shows a plan view of a brake lining apparatus 1 with a view of the frictional face 5, comprising a brake lining holder in the form of a brake lining rear plate 2 and a brake lining 4 fastened in a manner known per se on an application face 3 of the brake lining rear plate 2. The brake lining or the frictional face is identified in all figures by way of the hatched area.

As can be seen in FIG. 1, the size of the frictional face 5 is considerably less than 75% of the size of the application face of the brake lining rear plate 2. The size of the application face corresponds to the area enclosed by the outer black line 2. The size of the frictional face corresponds to the size of the hatched area.

To this end, the brake lining 4 has two large-area recesses 6 surrounded by brake lining material. The brake lining material extends along an outer edge region of the application face and along a wide transverse strip in the middle region. In cross section, the recesses have the shape of a rectangle, in which one corner is chamfered, with the result that a pentagon is formed. The contour of the recess is adapted to the contour of the outer edge region which likewise has a corresponding chamfer of an outer edge. The corners of the contour can also be rounded by way of radii.

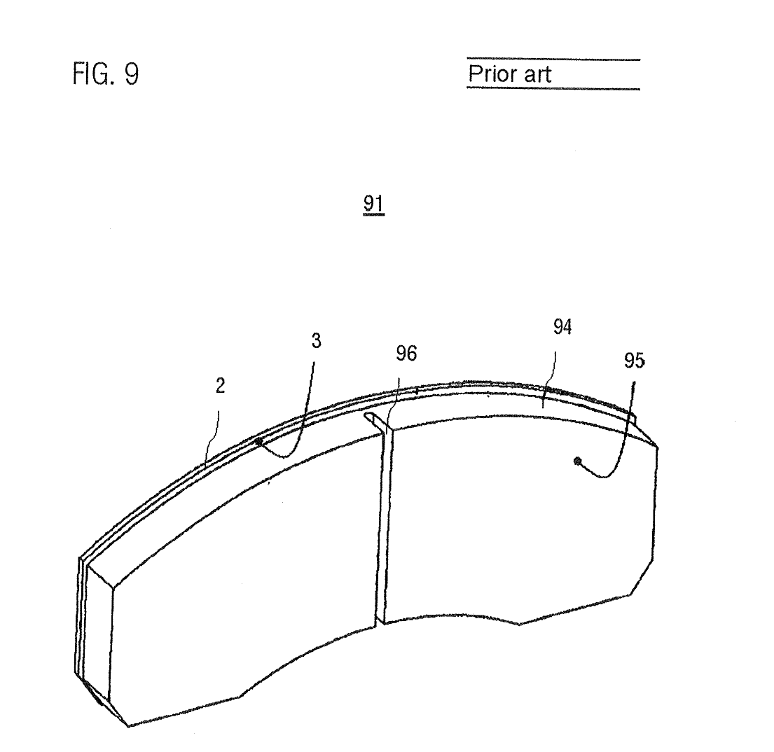

It is emphasized that the illustration in FIG. 1 and the following figures is merely diagrammatic, and that the actual basic shape of the brake lining rear plate 2 is usually slightly curved in practice for brake discs, as shown in FIG. 9. Here, the curved shape is omitted to simplify the illustration in FIGS. 1 to 8.

The following figures show alternative design variants by way of example which make it clear that a multiplicity of design variants are possible, in order to realize large-area recesses, with the result that the frictional face 5 configured by way of the lining upper side of the brake lining 4 is at most 75% of the size of the application face 3 of the brake lining rear plate 2. In the figures, the lining rear plate is identified in each case by way of the reference numeral 2 and the application face is identified in each case in turn by way of the reference numeral 3.

The special feature of the design variant of a brake lining apparatus 21, which is shown in FIG. 2, lies in the fact that two large-area cylindrical recesses 26 are made in the brake lining, which recesses 26 appear as circular recesses 26 in a plan view of the frictional face 25.

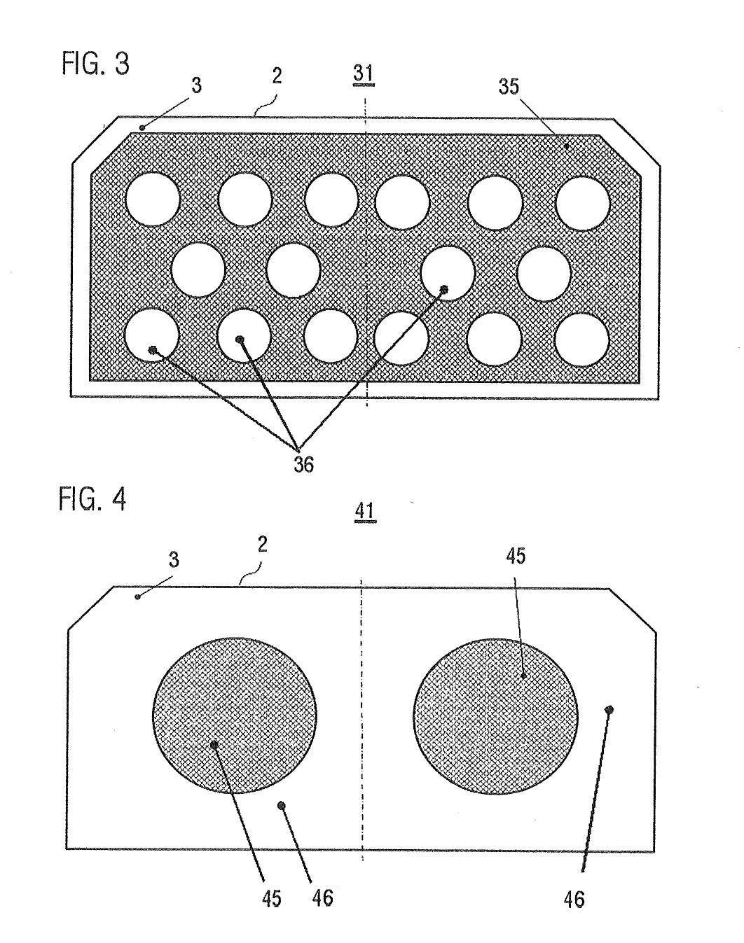

FIG. 3 shows a further variant of a brake lining apparatus 31, in which, instead of two large-area recesses 26, 16 smaller cylindrical recesses 36 are made in the brake lining 35, which recesses 36 appear as circular recesses in the plan view of the frictional face 35. The number of recesses can differ from the 16 recesses which are depicted here, and can have a lower or higher number.

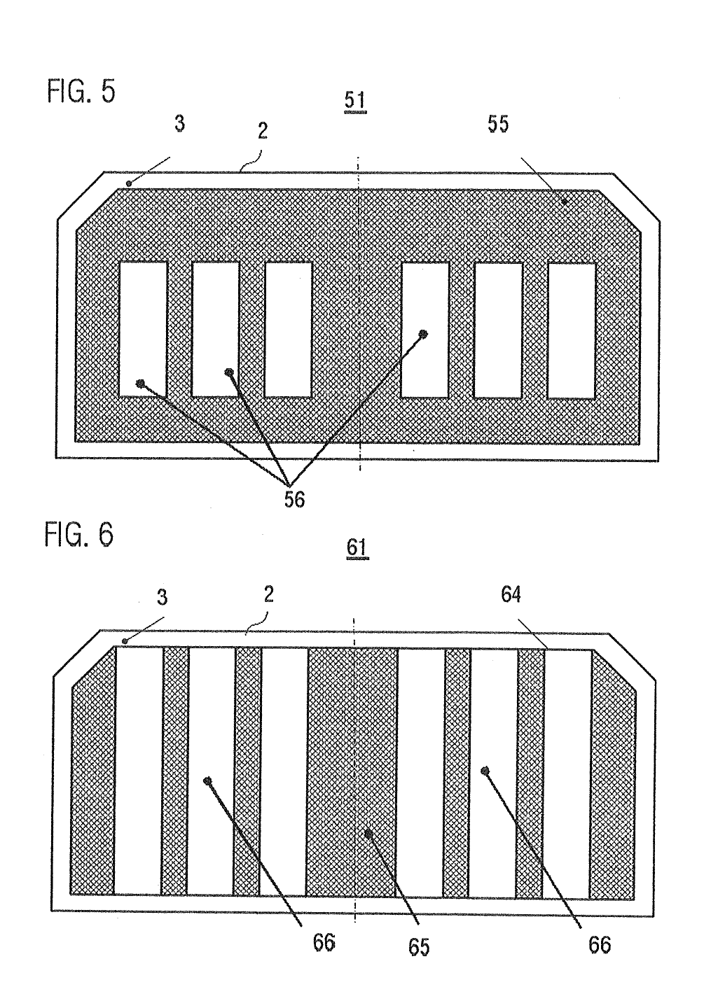

In the design variant of the brake lining apparatus 41 according to FIG. 4, instead of to the left and right of the centre of the application face 3, in each case one cylindrical lining material 45 is applied in a central region, which lining material 45 is surrounded by a large-area free surface 46, that is to say the free surface 46 corresponds to a region of the application face 3, on which no brake lining material is applied. In the design variants 51, 61 and 71 of FIGS. 5 to 7, the recesses are made as strip-shaped recesses in the lining material.

In the variant of FIG. 5, the frictional face 55 has six strip-shaped recesses 56 transversely arranged with respect to the longitudinal direction of the brake lining rear plate 2. Recesses 56 extend approximately over half the width of the lining surface 3. The frictional face 55, which is configured by way of the applied brake lining, covers at most 75% of the application face 3 of the brake lining rear plate 2. The number of recesses can differ from the six recesses which are depicted here, in terms of number and position.

According to the design variant 61 shown in FIG. 6, the recesses 66 pre-sent in the frictional face 65 extend from an edge region of the application face to an opposite edge region of the application face 3. Once again, six strip-shaped recesses 66 are made in the frictional face 65 of the brake lining 64 merely by way of example.

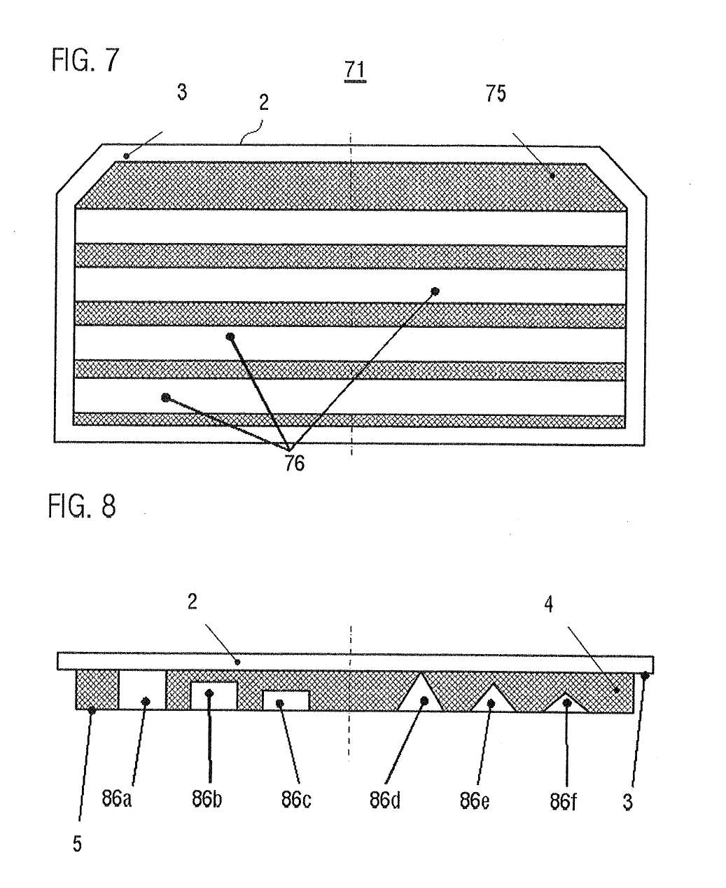

In the design variant 71 shown in FIG. 7, the strip-shaped recesses 76 do not ex-tend in the transverse direction, in contrast to FIG. 6, but rather in the longitudinal direction of the application face 3. Only four strip-shaped recesses 76 are made in the frictional face in the example that is shown. The frictional face 75, which is configured by way of the lining upper side of the brake lining, covers at most 75% of the application face 3 of the brake lining rear plate 2. The number of recesses can differ from the four recesses depicted here, in terms of number and position.

FIG. 8 shows a cross-sectional view to illustrate different variants of recesses. Recesses can either have a substantially constant cross section over their depth and, as a consequence, can be configured so as not to taper in the direction of the application face 3, which is shown by way of example using the recesses 86a, 86b and 86c. There is also the possibility, however, that the recesses taper in the direction of the lining rear plate 2 starting from the frictional face 5, which is illustrated, for example, by way of the recesses 86d to 86f. There is in each case the possibility here that the recesses are configured in such a way that they ex-tend from the frictional face 5 as far as the application face 3, with the result that the application face 3 is visible in a plan view of the frictional face 5. As an alternative, the recesses can also be configured such that they do not extend as far as the frictional face 3, that is to say the depth of the recesses is smaller than the depth of the brake lining material 4, which is shown, for example, using the recesses 86b, 86c, 86e and 86f. The tapered portions of the cut-outs which are shown in an angular or angled manner can also be provided with a radius.

The dimensions of the lining rear plate 2, the brake lining holder and the application face 3 in FIGS. 1 to 8 correspond to the typical connector dimensions of known brake callipers, brake carriers and brake discs which are different depending on the tire size. It is emphasized once again that the brake lining apparatuses according to the invention are provided for use with hybrid vehicles, in the case of which the greatest proportion of the braking performance is taken up by way of the recuperation operation, but is not restricted hereto. Similar negative lining effects can also occur in the case of other applications (not necessarily hybrid vehicles) with powerful permanent braking devices such as a retarder, in the case of which lining effects measures according to this invention become necessary. If the brake lining apparatus is used in vehicles of this type, the size of the frictional face can be reduced greatly in comparison with the prior art in relation to the size of the brake lining holder or its application face, and a sufficient braking performance and a long lining service life can nevertheless be provided. In addition, the surface pressure of the brake lining is increased during operation and, as a result, the problem of premature “falling asleep” (reduction in the coefficient of friction) of the brake linings is prevented.

Although the invention has been described with reference to defined exemplary embodiments, a person skilled in the art can see that various modifications can be performed and equivalents can be used as a replacement, without departing from the scope of the invention. In addition, many modifications can be carried out without departing from the associated scope. As a consequence, the invention is not to be restricted to the exemplary embodiments which are disclosed, but rather is to include all exemplary embodiments which fall within the scope of the appended patent claims. In particular, the invention also claims protection for the subject matter and the features of the subclaims independently of the claims which are referred to.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A brake lining apparatus for a disc brake, comprising:
a brake lining holder; and
a brake lining which is applied on an application face of the brake lining holder, wherein a frictional face of the brake lining which is a lining upper side of the brake lining is at most 75% of a size of the application face of the brake lining holder.

2. The brake lining apparatus according to claim 1, wherein one of:
(a) the frictional face is at most 60% of the size of the application face of the brake lining holder; and
(b) the frictional face is at most 50% of the size of the application face of the brake lining holder.

3. The brake lining apparatus according to claim 1, wherein the brake lining has recesses that extend from the frictional face to the application face.

4. The brake lining apparatus according to claim 1, wherein
(a) a fastening face of the brake lining arranged on a lining underside of the brake lining is fastened to the application face, and covers more than 75% of the application face; and
(b) the brake lining has recesses that extend from the frictional face toward the application face, but not as far as the application face.

5. The brake lining apparatus according to claim 1, wherein the frictional face has recesses that have a cross section that tapers toward the application face.

6. The brake lining apparatus according to claim 1, wherein the frictional face has strip-shaped recesses.

7. The brake lining apparatus according to claim 6, wherein at least one of:
(a) the strip-shaped recesses are configured as parallel recesses in one of longitudinal direction and a transverse direction;
(b) there are at least three strip-shaped recesses;
(c) the strip-shaped recesses extend from an edge region of the application face to an opposite edge region of the application face; and
(c2) the strip-shaped recesses are surrounded on a circumferential side by the brake lining.

8. The brake lining apparatus according to claim 1, wherein at least one of:
(a) the frictional face has two recesses that are each surrounded by brake lining;
(b) the frictional face has at least ten recesses that are each surrounded by brake lining; and
(c) the brake lining is applied flatly to the application face at two points that are separate from one another.

9. A hybrid vehicle, in particular commercial vehicle having a hybrid drive, having a brake lining apparatus comprising:
a brake lining holder; and
a brake lining which is applied on an application face of the brake lining holder (2),
wherein a frictional face of the brake lining which is a lining upper side of the brake lining is at most 75% of a size of the application face of the brake lining holder.

10. The brake lining apparatus according to claim 2, wherein the brake lining has recesses that extend from the frictional face to the application face.

11. The brake lining apparatus according to claim 4, wherein the fastening face of the brake lining covers more than 90% of the application face.

12. The brake lining apparatus according to claim 8, the recesses are one or more of cylindrical recesses and conical recesses.
